(19) United States
(12) Patent Application Publication
(10) Pub. No.: US 2010/0149973 A1
(43) Pub. Date: Jun. 17, 2010

(54) Method and Apparatus for use in a Communications Network

(76) Inventors: Daniel Krupp, Budapest (HU); Gergely Pongary, Budapest (HU)

Correspondence Address: ERICSSON INC., 6300 LEGACY DRIVE, M/S EVR 1-C-11, PLANO, TX, 75024, US

(21) Appl. No.: 12/445,053

(22) PCT Filed: Oct. 9, 2006
(86) PCT No.: PCT/EP06/67204

§ 371 Date: Mar. 3, 2010

(51) Int. Cl. H04L 12/26; H04L 12/66

(52) U.S. Cl. 370/230; 370/352; 370/236

(57) ABSTRACT

A method is provided of regulating a load placed on a first node (200) of a telecommunications network caused by transactions (Tr) sent to the first node (200) by a second node (100) of the network according to a signalling protocol between reached the first node (200) and the second node (100). The method comprises specifying a limit on the number of transactions sent from the second node (100) to the first node (200) for which a reply (R) has not yet been received, and adjusting the limit based on signals received at the second node (100) from the first node (200) that provide an indication of a level of load being experienced at the first node (200). In one example, the signalling protocol is the H.248 protocol, the signals comprise H.248.11 overload notifications, and the network is a Next Generation Network. The second node may be a gateway controller node and the first node may be a gateway node.

### BACKGROUND OF THE INVENTION

1. Field of the Invention

The present invention relates to a method and apparatus for use in a communications network.

2. Description of the Related Art

A Next Generation Network (NGN) is a packet-based network able to provide services including Telecommunication Services and able to make use of multiple broadband, QoS-enabled transport technologies and in which service-related functions are independent from underlying transport-related technologies. It offers unrestricted access by users to different service providers. It supports generalized mobility which will allow consistent and ubiquitous provision of services to users.

The IP Multimedia Subsystem (IMS) is a standardised control plane for the NGN architecture capable of handling Internet based multimedia-services defined by the European Telecommunications Standards Institute (ETSI) and the 3rd Generation Partnership Project (3GPP). IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. The IP Multimedia Subsystem (IMS) is a new subsystem added to the UMTS architecture in Release 5, for supporting traditional telephony as well as new multimedia services. Specific details of the operation of a UMTS communications network and of the various components within such a network can be found from the Technical Specifications for UMTS which are available from http://www.3gpp.org.

In Next Generation Networks (NGNs), H.248 (also knows as Media Gateway Control Protocol or “Megaco”; H.248 v2 protocol specification: draft-ietf-megaco-h248v2-04.txt) is a signalling protocol used between an access node (or Media Gateway) and a controller node (or Media Gateway Controller), and is used amongst other things for controlling the media setup of a call. The H.248 messages are processed on the central processing unit (CPU) of the corresponding nodes.

Different types of nodes have different signal processing capacity. Controller nodes, like Media Gateway Controllers (also known as call servers or call agents), have significantly higher processing capacity than access nodes, like Media Gateways. Because of that, there are scenarios where signalling overload in a specified access node caused by the controller node is likely.

Signalling overload causes the affected access node to respond with an increased delay. If overload continues, loss of messages or rejection will occur, and the access node's performance will degrade, or in the worst case the node will crash entirely. The access node is assumed to have an internal overload protection mechanism that is able to reject a part of the arriving stream of signalling messages in order to avoid a complete crash, but even in this case the access node throughput will drop if its processing capacity is significantly lower than the offered load. This is illustrated in FIG. 1, which shows access node behaviour in different load scenarios.

If the offered load is significantly higher than the capacity of the access node, the internal solution will not allow the access node to work with a high utilization and a quick response time. To improve the situation, the offered load can be controlled by an external load control function. It is desirable to provide such an external load control function that meets as many of the following requirements as possible:
To keep the access node in a stable state near its engineered capacity, while maintaining good resource utilization and throughput.
To limit the processing delay of the signalling messages, caused mainly by the large number of buffered requests at the overloaded node.
To share the controlled resource fairly between the users.

### SUMMARY OF THE INVENTION

According to a first aspect of the present invention there is provided a method of regulating a load placed on a first node of a telecommunications network caused by transactions sent to the first node by a second node of the network according to a signalling protocol between the first node and the second node, comprising specifying a limit on the number of transactions sent from the second node to the first node for which a reply has not yet been received, and adjusting the limit based on signals received at the second node from the first node that provide an indication of a level of load being experienced at the first node.

The method may comprise, when determining whether a new transaction is to be sent from the second node to the first node, deciding to send the transaction if the limit has not yet been reached.

The method may comprise, when determining whether a new transaction is to be sent from the second node to the first node, deciding to queue the transaction at the second node if the limit has already been reached.

The method may comprise deciding to queue the transaction at the second node only if the transaction has a high enough priority level associated with it, and otherwise rejecting the transaction.

The method may comprise selecting a queued transaction for sending to the first node after a reply is received from the first node to a previously-sent unreplied transaction, and sending the selected transaction.

The transaction may be selected at least partly according to its priority level.

The method may comprise removing a queued transaction after a predetermined time period has elapsed since the transaction was queued.

The signals may comprise overload notifications that are sent from the first node to the second node when the first node is determined to be in an overloaded condition.

The method may comprise adjusting the limit based on the number of overload notifications received at the second node from the first node during a predetermined time period, such as since the previous adjusting step.

The method may comprise adjusting the limit upwards if the number of overload notifications is less than or equal to a first predetermined threshold.

The method may comprise adjusting the limit upwards only if there has been at least a first predetermined number of transactions queued at the second node or if there has been at least a second predetermined number of transactions rejected by the second node during the predetermined time period.

The first and second predetermined numbers may both be one. Or one of the first and second predetermined numbers may be one.

The method may comprise adjusting the limit upwards by incrementing the limit.

The method may comprise adjusting the limit downwards if the number of overload notifications is greater than a second predetermined threshold.

The method may comprise adjusting the limit downwards by multiplying the limit by a predetermined factor having a value between 0 and 1.

The second predetermined threshold may be zero.

The first predetermined threshold may be zero.

The signals may comprise signals respectively in response to messages sent previously from the second node to the first node that allow an estimate of a roundtrip delay from the second node to the first node and back to the second node, the roundtrip delay providing an indication of the level of overload at the first node.

The method may comprise adjusting the limit within predetermined bounds.

The upper bound may be infinity.

The lower bound may be one.

The method may comprise performing the adjusting step at predetermined intervals.

The transactions may be of a type that can be rejected.

The second node may be a controller node and the first node may be a controlled node.

The second node may be a master node and the first node may be a slave node.

The second node may be a gateway controller node and the first node may be a gateway node.

The signalling protocol may be the H.248 protocol.

The overload notifications may comprise H.248.11 notifications.

The signalling protocol may be the Media Gateway Control Protocol.

The signalling protocol may be the Simple Gateway Control Protocol.

The signalling protocol may be the Internet Protocol Device Control.

The transactions may comprise signalling transactions.

The network may be a Next Generation Network.

According to a second aspect of the present invention there is provided an apparatus for use as or in a second node of a telecommunications network, the second node being adapted to send transactions to a first node of the network according to a signalling protocol between the first node and the second node, the apparatus comprising means for specifying a limit on the number of transactions sent from the second node to the first node for which a reply has not yet been received, and means for adjusting the limit based on signals received at the second node from the first node that provide an indication of a level of load being experienced at the first node.

According to a third aspect of the present invention there is provided a program for controlling an apparatus to perform a method according to the first aspect of the present invention.

The program may be carried on a carrier medium.

The carrier medium may be a storage medium.

The carrier medium may be a transmission medium.

According to a fourth aspect of the present invention there is provided an apparatus programmed by a program according to the third aspect of the present invention.

According to a fifth aspect of the present invention there is provided a storage medium containing a program according to the third aspect of the present invention.

### BRIEF DESCRIPTION OF THE DRAWINGS

FIG. 1 is a graph illustrating access node behaviour in different load scenarios;

FIG. 2 is a block diagram illustrating parts of a media gateway controller apparatus embodying the present invention in communication with a media gateway apparatus;

FIG. 3 is a flowchart illustrating a transaction handling procedure performed by a new transaction handler part of the media gateway controller apparatus of FIG. 2;

FIG. 4 is a flowchart illustrating a transaction response handling procedure performed by a transaction response handler part of the media gateway controller apparatus of FIG. 2;

FIG. 5 is a flowchart illustrating an overload handling procedure performed by an overload handler part of the media gateway controller apparatus of FIG. 2;

FIG. 6 is a flowchart illustrating a queued transaction timeout handling procedure performed by a queued transaction timeout handler part of the media gateway controller apparatus of FIG. 2;

FIG. 7A is a plot showing admitted call rate, CPU utilization of the gateway, and the queuing delays in a simulation of a previously considered overload handling method; and

FIG. 7B is a plot showing admitted call rate, CPU utilization of the gateway, and the queuing delays in a simulation of an overload handling method according to an embodiment of the present invention, for comparison with FIG. 7A.

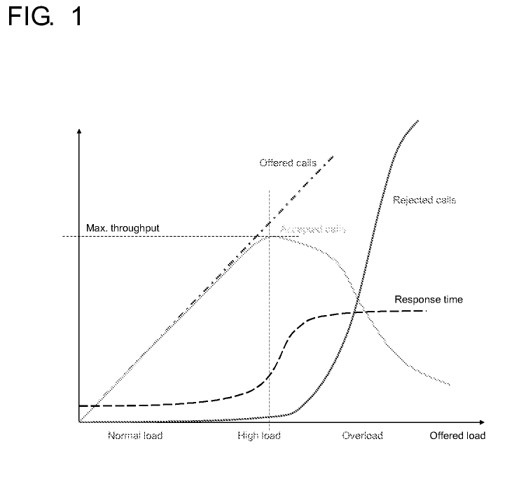

### DETAILED DESCRIPTION OF THE PREFERRED EMBODIMENTS

As mentioned above, it is desirable to provide a function to control loads on an access node such as a Media Gateway. The following four separate approaches for controlling the load have been previously considered.

Firstly, there is a drop and resend approach, which is perhaps the simplest way to limit response time on the overloaded node. With such an approach, signalling messages are dropped after a given buffer size, and resent later from the external node.

However, a disadvantage with the drop and resend approach is that dropping a signalling message results in high end-to-end delay from the subscriber's perspective. Moreover, it is very probable that there are a number of nodes needed to cooperate to create a voice call. If one node drops a message, the processing on other nodes may cause unnecessary load, or may block resources even they do not need to be blocked.

Secondly, there is a window-based approach, in which the number of requests that can be outside on the network in a given time is limited to the size of a specified window. The window on the overloading entity can be either static (fixed size) or dynamic (adjusted real-time). It is important that, in this case, the reply can only be sent if the original message is fully processed. TCP/SCTP (Transmission Control Protocol/Stream Control Transmission Protocol) finds the bandwidth limitation due to packet loss, in which case it decreases the sender window size.

However, a disadvantage with the window-based approach is that, in the static case, it is hard to find a value that will be suitable for all cases. Too small a static window will cause calls to be rejected long before the capacity limit is reached, especially if the calls arrive in bursts. Too large a static window, on the other hand, will allow a large queue to be built up and thus leads to a large processing delay on the overloaded entity. Current adaptive window solutions mainly use packet loss to find the limits of a network path. However, packet loss is sometimes unacceptable (as described above with respect to the drop and resend approach).

Thirdly, there is an overloaded entity controlled congestion handling approach (e.g. H.248.10; Media Gateway Resource Congestion Handling Package (H.248.10): ITU-T H.248 Annex M.2). In this approach, the overloaded entity calculates its real processing capacity and signals it to the connected external nodes. The explicit rate signalled by the overloaded entity is then applied in the external nodes thus decreasing the load. Regulation may use leaky bucket or percentage based rate control.

However, this explicit, H.248.10 like, notification approach has a disadvantage that an overloaded entity must take care of measuring its load, calculating its available capacity and signalling it to the non-overloaded entities. This causes even more load, while this notification has to be very fast and precise.

Finally, there is a congestion signal based approach (e.g. H.248.11; H.248.11 extension specification: ITU-T recommendation H.248.11). With this approach, the node signals an overload indication flag if it is overloaded. This flag is sent as a reply to every connection request, so the higher load an external node generates the higher rate of overload notifications it gets. Using this rate the external node can regulate its load using a leaky bucket restrictor.

However, a disadvantage with the congestion signal based approach is that the node also needs to monitor its load characteristics, and signal overload indication in case of overload. The control is split into two nodes, and the far end node can only rely on the number of overload indication messages it gets, and nothing more.

In spite of the above-described disadvantages with previously considered approaches, the applicant has appreciated that a significant advantage of the window-based approach is that even a static window offers quite good adaptation to different load situations by automatically reducing the signal rate if the processing capacity of the overloaded entity decreases. Separately, the applicant has appreciated that the congestion signal (H.248.11) based approach has the advantage that the system is under full control, and an overload situation can be very well predicted before it actually happens.

Having appreciated and balanced the various disadvantages set out above with the advantages of the window and congestion signal based approaches, the applicant has devised an embodiment of the present invention in which the window and congestion signal based approaches are effectively combined, where an adaptive window size can be used and where the adaptation relies on congestion signals.

In a highly overloaded network, low capacity nodes (such as Media or Access Gateways) that are connected to one or more high capacity nodes (such as Media Gateway Controllers) may become overloaded by the excessive signalling traffic. Media Gateways repetitively measure their overload status and send H.248.11 overload notifications to the controlling entity in order to make them throttle the signalling traffic.

In an embodiment of the present invention, the signalling traffic is regulated with a windowing mechanism, with the window sizes being dynamically set according to the overload status. The window size adjustment can equally be based on roundtrip delay measurements (on the Media Gateway Controller side) or based on H.248.11 notifications. An embodiment of the present invention will now be described that is based upon the latter approach, that is where H.248.11 overload notification messages drive the window sizes, but other approaches are of course possible. The Media Gateway Controller (MGC) applies control to keep the response time of the gateway reasonably low while providing high call handling throughput.

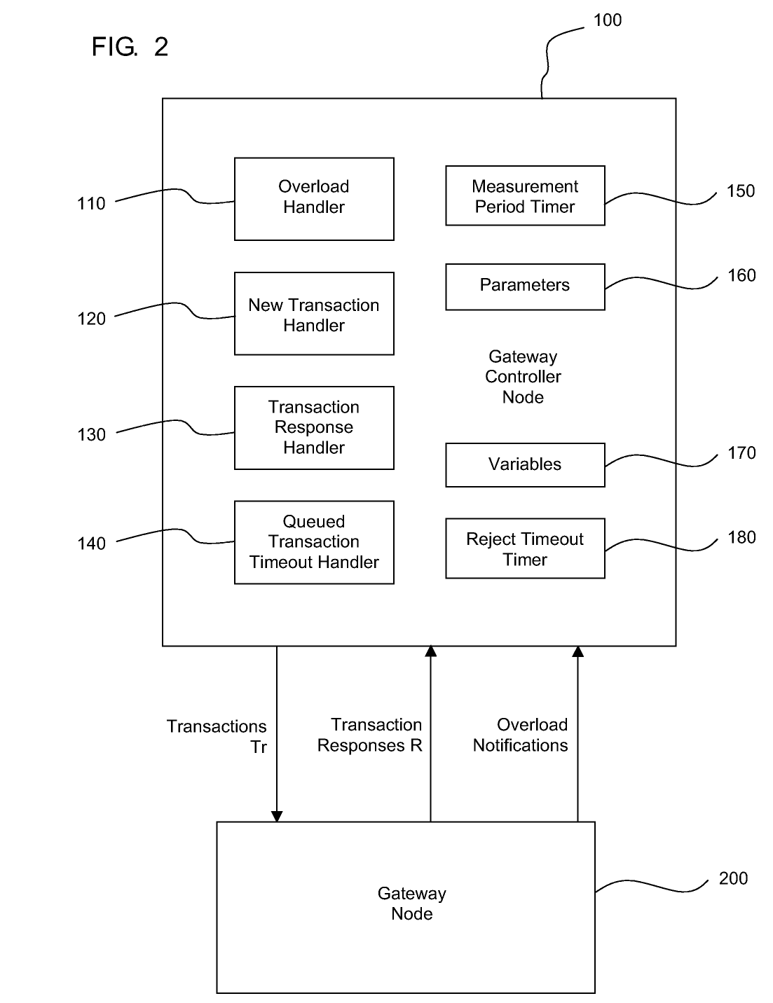

FIG. 2 is a block diagram illustrating parts of an apparatus embodying the present invention. A media gateway controller (controller node) 100 embodying the present invention comprises an overload handler 110, a new transaction handler 120, a transaction response handler 130, a queued transaction timeout handler 140, a measurement period timer 150, a store of parameters 160, a store of variable 170, and a reject timeout timer 180. The media gateway controller 100 is in communication with a media gateway (gateway node) 200, sending transactions Tr thereto, and receiving transaction responses R and overload notifications therefrom, as will be described in more detail below.

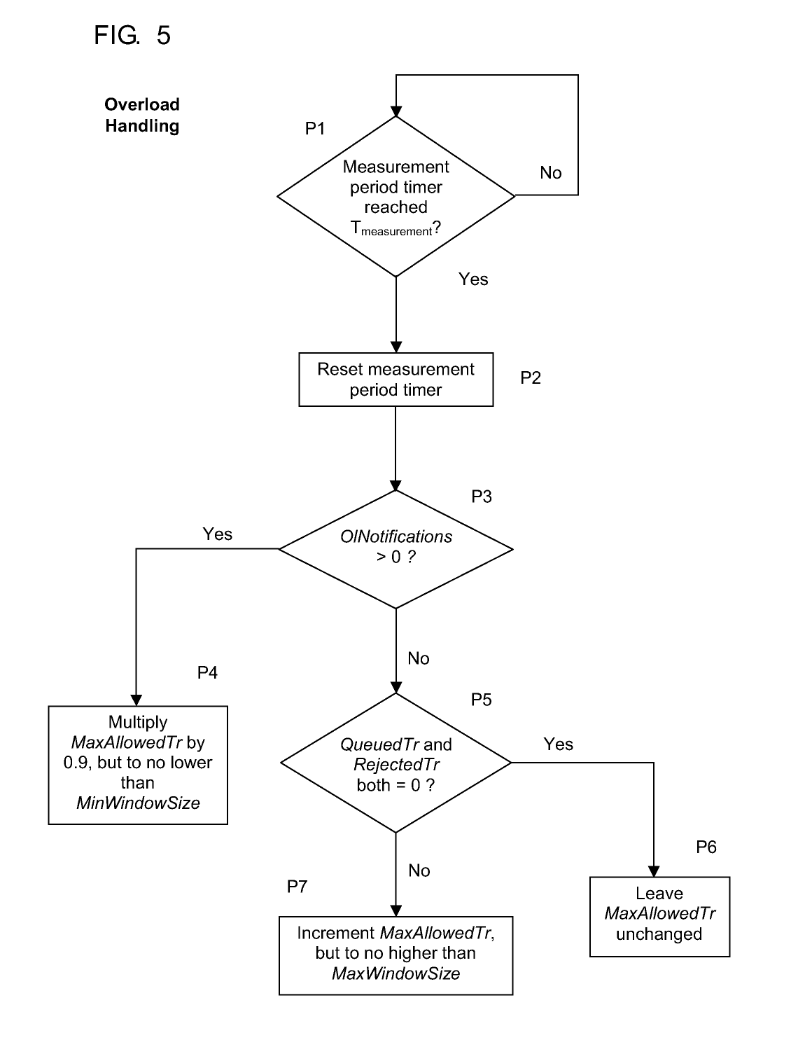

The measurement period timer 150 is used to control the measurement aggregations and the window adaptation decisions. After every time interval of Tₘₑₐₛᵤᵣₑₘₑₙₜ, the window size is adjusted according to the number of received H.248.11 overload notification messages. A typical value for Tₘₑₐₛᵤᵣₑₘₑₙₜ is 1 to 5 secs. This is described in more detail below with reference to FIG. 5.

The variables used in a method embodying the present invention, which are stored in and accessed from the parameters store 160, are summarised in Table 1 below, while the configurable parameters, stored in and accessed from the variables store 170, are summarised in Table 2 below.

TABLE 1

| Variable | Summary | Description |
|---|---|---|
| Priority | Transaction priority | Every queued transaction will be |
| | | assigned a priority level according to the |
| | | type of the call (emergency or normal), |
| | | the A or the B numbers. |
| QueuedTr | Current number of queued | This indicates the total number of queued |
| | transactions | transactions in the priority queues toward |
| | | a GW. |
| OngoingTr | Current number of | This indicates the number of unreplied |
| | ongoing transactions | rejectable transactions sent to the GW. |
| MaxAllowedTr | Currently allowed | This indicates the maximum number of |
| | maximum transactions | transactions that can be ongoing to a |
| | (window size) | specific GW. This value is updated |
| | | during overload conditions. |
| RejectedTr | Number of rejected | Number of rejected (which could not be |
| | transactions | queued) transactions during Tₘₑₐₛᵤᵣₑₘₑₙₜ |
| | | period. |
| OlNotifications | Number of Overload | Indicates the number of H.248.11 |
| | Notifications | overload notifications received in the |
| | | current Tₘₑₐₛᵤᵣₑₘₑₙₜ period. |

TABLE 2

| Parameter | Summary | Description |
|---|---|---|
| MinWindowSize | Minimum size of the | OngoingTr variable cannot |
| | transaction window | go below this parameter. |
| MaxWindowSize | Maximum size of the | OngoingTr variable cannot |
| | transaction window | go above this parameter |

Suitable values for the configurable parameters are MinWindowSize=1 and MaxWindowSize=infinity (i.e. no limit to the transaction window maximum size, MaxAllowedTr).

Different load control related functions are invoked during the processing of a call, and also periodically. The following events can be defined, and are described separately below:
Transaction Handling (at new call requests)
Transaction Response Handling (at response to a transaction from the gateway)
Overload Handling (periodically)

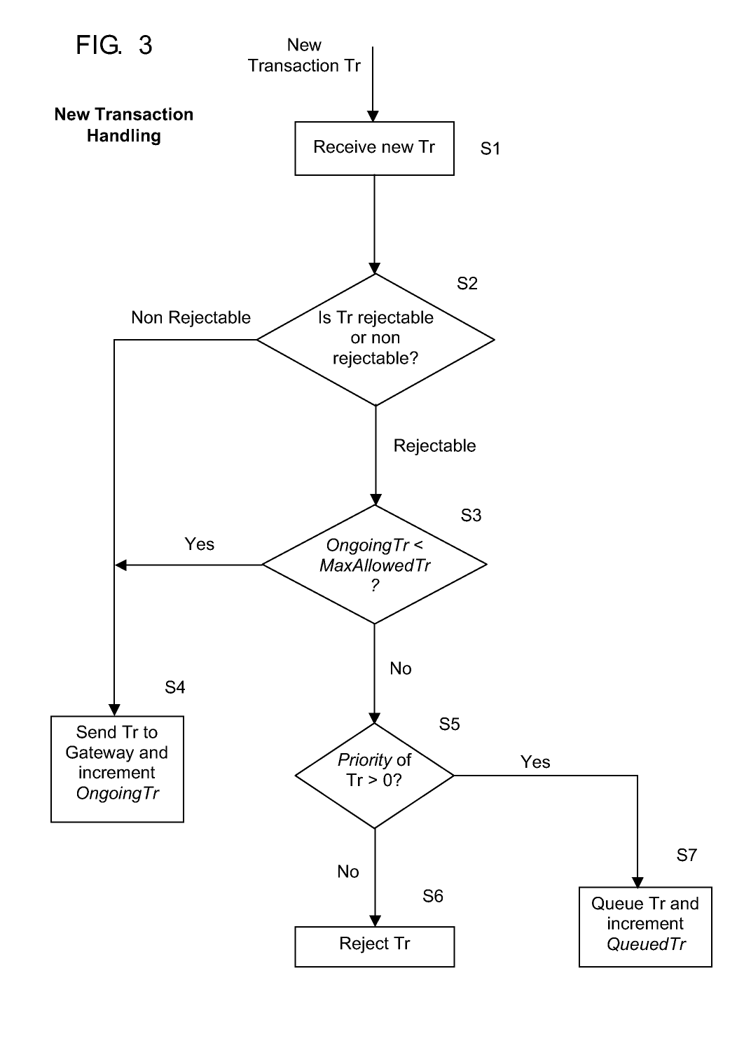

Transaction handling by the new transaction handler 120 in this embodiment of the present invention will now be described with reference to the flowchart of FIG. 3.

A call setup consists of multiple transactions Tr that are to be sent toward the media gateway 200. In step S1, such a new transaction Tr is received at the media gateway controller 100. It is possible to differentiate between rejectable and non-rejectable transactions in a call setup. Typically, the first H.248 ADD transaction is rejectable, because at that point the call can be rejected. All other subsequent transactions belonging to an admitted call are non-rejectable as they have to be sent toward the gateway immediately without consideration to the current overload status of the gateway.

Each call is associated with a priority level between 0 and 15 which determines whether the call setup request (the first rejectable transaction) can be queued or not. If the lowest number is associated with the lower priority then a normal call could have priority 0 and an emergency call priority 1 (or higher).

Only rejectable transactions belonging to priority class above 0 are queued. When such a transaction is queued a T_{reject} timer is started for the transaction. If the timer expires before the transaction is admitted then it is removed from the queue and call is rejected.

In step S2 it is determined whether the transaction Tr received in step S1 is rejectable or non-rejectable. If it is non-rejectable, processing passes to step S4, in which the transaction Tr is sent to the gateway 200 and the variable OngoingTr is accordingly incremented. (Alternatively, non-rejectable transactions can be treated separately from rejectable transactions, and in that case it could be arranged that the number of ongoing non-rejectable transactions does not affect the variable OngoingTr.)

When a new rejectable transaction is to be processed it is checked whether sufficient resources are currently available.

In doing so, it is determined in step S3 whether OngoingTr<MaxAllowedTr. If so, then processing passes to step S4 in which the call is admitted and the variable OngoingTr is incremented.

If OngoingTr is not less than MaxAllowedTr then the subsequent treatment depends on the priority of the call, which is tested in step S5. If it is determined in step S5 that the call has higher priority than 0, then it is queued to the priority queue which corresponds to the call's priority class and the counter QueuedTr is incremented (step S7).

If, on the other hand, it is determined in step S5 that the call has a priority of 0, then it is rejected immediately (step S6).

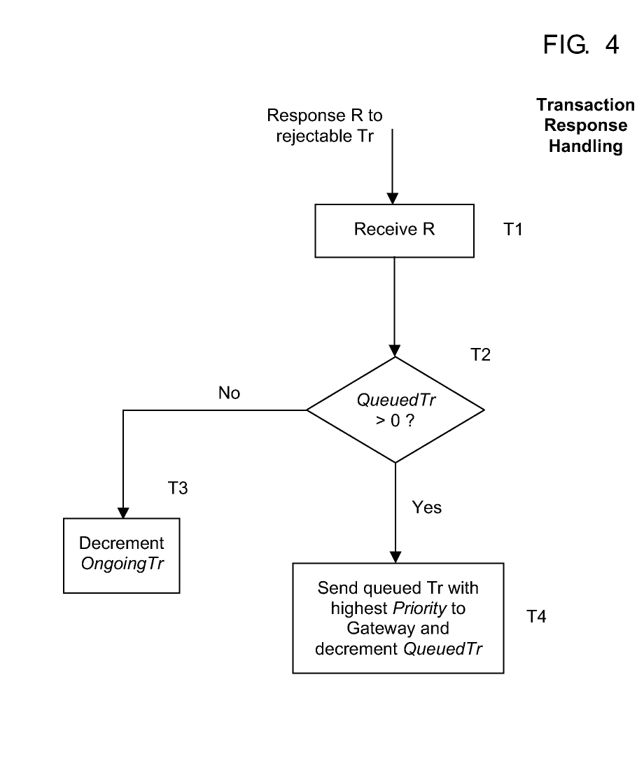

Transaction response handling by the transaction response handler 130 in this embodiment of the present invention will now be described with reference to the flowchart of FIG. 4.

Transaction response handling occurs when the media gateway controller 100 receives in step T1 a transaction response R from the media gateway 200 to a rejectable transaction. At this point it is checked whether there is any queued transaction which could be sent toward the gateway in place of the processed transaction.

When response to a rejectable transaction is received from the media gateway 200, it indicates that the resource became free. In this embodiment, there are two possible courses of action, determined by whether or not the variable QueuedTr is greater than 0, which is determined in step T2.

If QueuedTr>0, then processing passes to step T4 where the last arrived call with the highest priority is taken out from the priority queue and sent towards the media gateway 200, and QueuedTr is decremented.

On the other hand, if it is determined in step T2 that the variable QueuedTr is equal to 0, then in step T3 the variable OngoingTr counter is decremented.

Overload handling by the overload handler 110 in this embodiment of the present invention will now be described with reference to the flowchart of FIG. 5.

Essentially, the overload condition is checked at the end of every Tₘₑₐₛᵤᵣₑₘₑₙₜ time interval (steps P1 and P2), and the number of queued, rejected calls and the number of H.248.11 Overload Notifications are checked in order to determine the status of the given gateway. Therefore, according to the QueuedTr, RejectedTr and OlNotifications variables the media gateway controller 100 adjusts the MaxAllowedTr variable as follows.

In step P3 it is determined whether the variable OlNotifications is greater than 0. If so, then in step P4 the variable MaxAllowedTr is updated according to the following formula: MaxAllowedTr=0.9×MaxAllowedTr. This update is performed taking into account the requirement that MaxAllowedTr cannot go below MinWindowSize or go above MaxWindowSize.

On the other hand, if it is determined in step P3 that OlNotifications=0, then there are two possible options in this embodiment. It is determined in step P5 whether QueuedTr=0 and RejectedTr=0. If so, then the window is essentially not restricting the traffic, so no change is needed to the variable MaxAllowedTr (step P6). Otherwise, the variable MaxAllowedTr is incremented by 1 to allow one more ongoing call to the media gateway 200. This update is performed taking into account the requirement that MaxAllowedTr cannot go below MinWindowSize or go above MaxWindowSize.

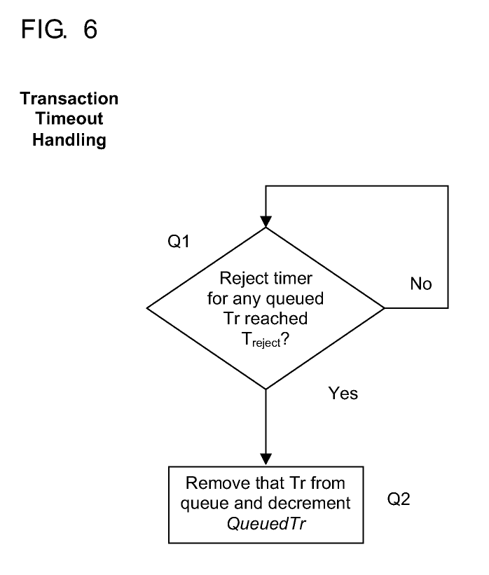

In addition to the above, the reject timeout timer 180 is used to timeout (and reject) transactions that sit too long (greater than a time T_{reject}) in the transaction queues on the media gateway controller. A typical value for T_{reject} is 1 sec. A method performed for this purpose by the queued transaction timeout timer 140 is summarised by the flowchart of FIG. 6. In step Q1 it is determined whether a reject timeout timer 180 relating to any queued transaction has reached T_{reject}. If so, that transaction is removed from the queue and the variable QueuedTr is decremented.

From the point of view of the media gateway 200, consideration has to be given to setting proper thresholds for detecting overload at the media gateway 200. The media gateway 200 sends H.248.11 Overload Notifications in reply to an ADD transaction if at the moment of message processing the gateway considers its status as overloaded. This decision can be made for example by comparing the message processing queue size to a predefined queue threshold. However, the sum of the minimum window sizes of the MGCs connected to the given gateway determines the number of ongoing calls simultaneously handled by the connected gateway. If the queue threshold is set too low than the H.248.11 overload notifications will be constantly sent causing the window sizes to stay at their configured minimum (however this is not necessarily a problem).

It is illustrative to compare the performance of a method embodying the present invention as described above with that suggested in the H.248.11 standard. Simulations with the NS-2 simulator (Network Simulator version 2) were carried out to prove the concept described according to an embodiment of the present invention. In the simulations, three controller nodes (MGCs) 100 were used to demonstrate the effect of changing the external intensity and the processing capacity, variable call intensity and background traffic.

In the simulations, the processing capacity of the media gateway 200 was changed according to the following (where 100% capacity is 25 calls/sec):
95% for 200 seconds.
80% for 200 seconds.
95% for 300 seconds.
60% for 200 seconds.
90% for 200 seconds.

The aggregated external call intensity profile (coming from the controllers 100) was the following:
12.5 cps for 100 seconds (50% load)
55 cps for 400 seconds (220% load)
20 cps for 100 seconds (80% load)
55 cps for 200 seconds (200% load)
250 cps for 200 seconds (1000% load)
5 cps for 100 seconds (20% load)

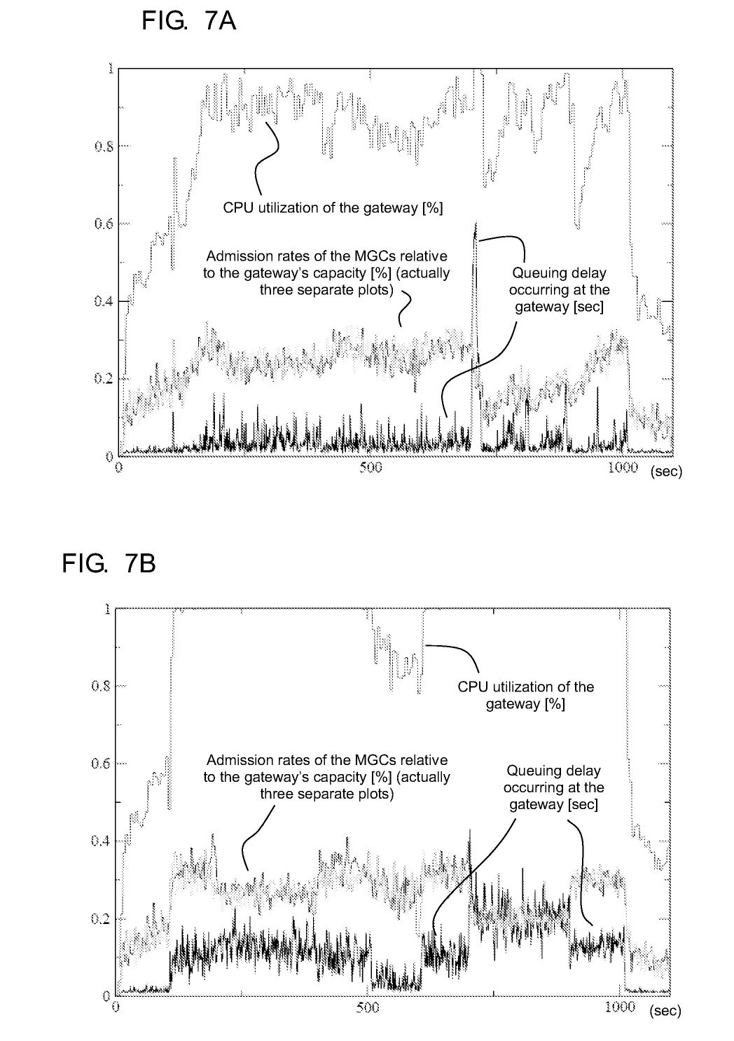

In FIGS. 7A and 7B, the admitted call rate, the CPU utilization of the gateway and the queuing delays are shown for the two methods using the above overload scenario.

FIG. 7A shows the results using the previously-proposed (leaky bucket based) H.248.11 load control algorithm. It is clear that the goal to limit the queuing delay, and thus the call setup delay, is fulfilled. The algorithm results in a reasonable performance, as it can be seen on the admitted rate curves.

FIG. 7B shows the results using a combined H.248.11 window based load control algorithm embodying the present invention. It is clear that the utilization in this case is much better, as the windowing mechanism guarantees 100% utilization during overload. That means less rejected calls, which results in revenue increase. The queuing delay is a little larger, although still limited in this case. That is also the result of the windowing mechanism. The processing delay on the gateway depends on the queue length, which is essentially the sum of the window sizes on the controllers.

The processing delay in overload cannot be smaller than the sum of the minimal window sizes (that is one call per controller and three controllers means three calls) multiplied by the time needed to create a call (that is 40 msec if 100% processing capacity is available).

On the other hand, control is very fast and efficient in this way, which is clear when the reaction of the two algorithms is compared for the sudden capacity change at 700 and 900 secs.

The previously-proposed H.248.11 method reacts slowly, which builds up a large delay (˜0.5 sec) for about 25 seconds. After 25 seconds, the delay is minimized again, but the rate is underestimated, which results in capacity drop (to ˜70% utilization) for about 50 seconds. At 900 seconds, where the processing capacity increases, the original algorithm finds the new capacity with difficulties, which results in ˜50 sec underutilized period (60 to 70%).

An algorithm embodying the present invention finds the available processing capacity easily, maintaining 100% utilization in all cases, while limiting the delay effectively even during the capacity and/or intensity changes.

Note that an algorithm embodying the present invention behaves even better (allows lower delays) in the case of gateways with higher call handling capacity. In these simulations, the profile of a low-end access gateway was used with an average call capacity of only 25 calls/second. For example in case of a high-end media gateway with 250 calls/second capacity the delay can be limited to ˜20 msec (if it is a requirement).

As demonstrated above, an embodiment of the present invention can successfully control H.248 signalling traffic during periods with excessive load. It is equally applicable to regulate the admitted traffic toward Media Gateways and Access Gateways. In the above described embodiment, the load control is triggered by H.248.11 overload notification messages. It is able to keep the call setup delay low while providing maximum throughput.

One of the greatest advantages of an embodiment of the invention over the previously-considered H.248.11 algorithm is its simplicity. Effectively there is no need for configuration on the MGC node, as the default values for minimum and maximum window size are good for almost every case. So the only values that are needed are the thresholds on the protected gateways that control how H.248.11 overload notifications are created.

In summary:
An embodiment of the present invention provides a simple (compared to the previous proposal) and efficient solution for handling H.248 signalling overload in Next Generation Networks.
It is difficult to mis-configure the parameters, as on the controller node only the minimum and the maximum window sizes are needed to be specified, but even for these parameters the default values (1 and infinite) can be used in substantially all cases.
Adaptive window sizes enables the capacity of the controlled gateway to be used with great efficiency in both overload and non-overload cases.
The windowing mechanism provides stable and effective control as it reacts quickly to capacity changes on the gateways, and moreover it enables an improved throughput.
If more than one MGC is connected to a gateway, the admitted traffic is shared fairly between the sources.
The priority queuing means that a lower priority is not admitted in favour of a higher priority call.
An embodiment of the present invention can limit the queuing delay to a small value which can be easily calculated by the minimum window sizes, the number of MGCs and the gateway's message processing capacity. However, higher delay thresholds can also be set and guaranteed.

Although the above embodiments have been described in relation to communications between a gateway controller node and a gateway node, it will be appreciated that the invention is applicable more generally for load control on any type of network node that receives load-related signalling from another node of the network.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1. A method of regulating a load, placed on a first node of a telecommunications network, caused by transactions sent to the first node by a second node of the network according to a signalling protocol between the first node and the second node, comprising:
at the second node specifying a limit on the number of transactions sent from the second node to the first node for which a reply has not yet been received, and
adjusting the limit based on signals received at the second node from the first node that provide an indication of a level of load being experienced at the first node.

2. The method as claimed in claim 1, comprising, when determining whether a new transaction is to be sent from the second node to the first node, deciding to send the transaction if the limit has not yet been reached.

3. The method as claimed in claim 1, comprising, when determining whether a new transaction is to be sent from the second node to the first node, deciding to queue the transaction at the second node if the limit has already been reached.

4. The method as claimed in claim 3, comprising deciding to queue the transaction at the second node only if the transaction has a high enough priority level associated with it, and otherwise rejecting the transaction.

5. The method as claimed in claim 3, comprising selecting a queued transaction for sending to the first node after a reply is received from the first node to a previously-sent unanswered transaction, and sending the selected transaction.

6. The method as claimed in claim 5, wherein the transaction is selected at least partly according to its priority level.

7. The method as claimed in claim 4, comprising removing a queued transaction after a predetermined time period has elapsed since the transaction was queued.

8. The method as claimed in claim 1, wherein the signals comprise overload notifications that are sent from the first node to the second node when the first node is determined to be in an overloaded condition.

9. The method as claimed in claim 8, comprising adjusting the limit based on the number of overload notifications received at the second node from the first node during a predetermined time period, including since the previous adjusting step.

10. The method as claimed in claim 9, comprising adjusting the limit upwards if the number of overload notifications is less than or equal to a first predetermined threshold.

11. The method as claimed in claim 10, comprising adjusting the limit upwards only if there has been at least a first predetermined number of transactions queued at the second node or if there has been at least a second predetermined number of transactions rejected by the second node during the predetermined time period.

12. The method as claimed in claim 11, wherein the first and second predetermined numbers are both one.

13. The method as claimed in claim 10, comprising adjusting the limit upwards by incrementing the limit.

14. The method as claimed in claim 9, comprising adjusting the limit downwards if the number of overload notifications is greater than a second predetermined threshold.

15. The method as claimed in claim 14, comprising adjusting the limit downwards by multiplying the limit by a predetermined factor having a value between 0 and 1.

16. The method as claimed in claim 14, wherein the second predetermined threshold is zero.

17. The method as claimed in claim 10, wherein the first predetermined threshold is zero.

18. The method as claimed in claim 1, wherein the signals comprise signals in response to messages sent previously from the second node to the first node that allow an estimate of a roundtrip delay from the second node to the first node and back to the second node respectively, the roundtrip delay providing an indication of the level of overload at the first node.

19. The method as claimed in claim 1, comprising adjusting the limit within predetermined bounds.

20. The method as claimed in claim 19, wherein the upper bound is infinity.

21. The method as claimed in claim 19, wherein the lower bound is one.

22. The method as claimed in claim 1, comprising performing the adjusting step at predetermined intervals.

23. The method as claimed in claim 1, wherein the transactions are of a type that can be rejected.

24. The method as claimed in claim 1 wherein the second node is a controller node and the first node is a controlled node.

25. The method as claimed in claim 1, wherein the second node is a master node and the first node is a slave node.

26. The method as claimed in claim 1, wherein the second node is a gateway controller node and the first node is a gateway node.

27. The method as claimed in claim 1, wherein the signalling protocol is the H.248 protocol.

28. The method as claimed in claim 27, wherein the overload notifications comprise H.248.11 notifications.

29. The method as claimed in claim 1, wherein the signalling protocol is Media Gateway Control Protocol.

30. The method as claimed in claim 1, wherein the signalling protocol is Simple Gateway Control Protocol.

31. The method as claimed in claim 1, wherein the signalling protocol is Internet Protocol Device Control.

32. The method as claimed in claim 1, wherein the transactions comprise signalling transactions.

33. The method as claimed in claim 1, wherein the network is a Next Generation Network.

34. An apparatus for use as or in a second node of a telecommunications network, the second node being adapted to send transactions to a first node of the network according to a signalling protocol between the first node and the second node, the apparatus comprising
means for specifying a limit on the number of transactions sent from the second node to the first node for which a reply has not yet been received, and
means for adjusting the limit based on signals received at the second node from the first node that provide an indication of a level of load being experienced at the first node.

35-40. (canceled)
